(19) United States
(12) Patent Application Publication
(10) Pub. No.: US 2026/0067749 A1
(43) Pub. Date: Mar. 5, 2026

(54) A SYSTEM FOR PROVIDING EPHEMERIS TRANSMISSION IN NON- TERRESTRIAL NETWORKS

(71) Applicant: TURKCELL TEKNOLOJI ARASTIRMA VE GELISTIRME ANONIM SIRKETI, Istanbul (TR)

(72) Inventor: Mehmet Izzet SAGLAM, ISTANBUL (TR)

(73) Assignee: TURKCELL TEKNOLOJI ARASTIRMA VE GELISTIRME ANONIM SIRKETI, Istanbul (TR)

(21) Appl. No.: 19/105,837

(22) PCT Filed: Dec. 30, 2022
(86) PCT No.: PCT/TR2022/051719

§ 371 Date: Feb. 24, 2025

(30) Foreign Application Priority Data
Aug. 24, 2022 (TR) 2022/013303

(51) Int. Cl. H04W 28/06; H04B 7/185

(52) U.S. Cl. CPC H04W 28/06; H04B 7/1851; H04B 7/1853

(57) ABSTRACT

The present invention relates to a system for providing power save while transmitting ephemeris data from satellites to telephones/user devices, and reducing the signalling load created by system information.

### TECHNICAL FIELD

The present invention relates to a system for providing power save while transmitting ephemeris data from satellites to telephones/user devices, and reducing the signalling load created by system information.

### BACKGROUND OF THE INVENTION

Today, a transition algorithm carried out between satellites is recommended for non-terrestrial networks. In addition, the time advance value is adjusted in order to prevent signals of different user devices from leading to interference of uplink requests in 5G next generation non-terrestrial connections. However, it is observed that power save cannot be performed and signalling load does not reduce in the said process.

Therefore, considering the studies and the deficiencies included in the current technique, it is understood that there is need for a system for providing power save while transmitting ephemeris data from satellites to telephones/user devices, and reducing the signalling load created by system information.

The European Patent Office document no. EP3905546A1, an application in the state of the art, discloses a system for facilitating efficient beam transmission in non-terrestrial networks. The system of the said invention, a user equipment comprises a transceiver which, in operation, indicates the coverage area candidate satellite beams relative to a location of at least one satellite generating a candidate satellite beam and receives the coverage area information. The user equipment comprises a circuitry which determines, based on the received coverage area information, ephemeris data of the at least one satellite generating a candidate satellite beam, a location of the user equipment and a target satellite beam for switching. In addition, the it controls the transceiver to perform switching to the determined target satellite beam at the determined switching timing for switching to the candidate satellite beam and the target satellite beam.

### SUMMARY OF THE INVENTION

An objective of the present invention is to realize a system for providing power save while transmitting ephemeris data from satellites to telephones/user devices, and reducing the signalling load created by system information.

### DETAILED DESCRIPTION OF THE INVENTION

“A System for Providing Ephemeris Transmission in Non-Terrestrial Networks” realized to fulfil the objectives of the present invention is shown in the figures attached, in which:

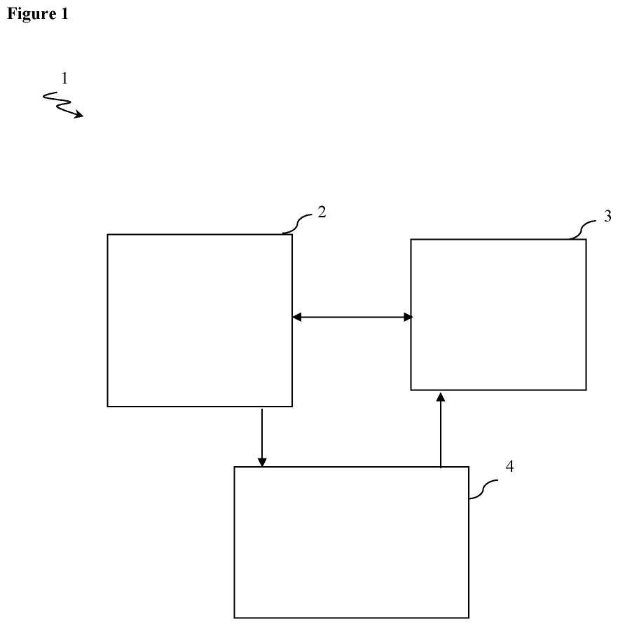

FIG. 1 is a schematic view of the inventive system.

The components illustrated in the figure are individually numbered, where the numbers refer to the following:
1. System
2. gNodeB base station
3. Electronic device
4. Server

The inventive system (1) for providing power save while transmitting ephemeris data from satellites to telephones/user devices, and reducing the signalling load created by system information comprises:
a gNodeB base station (2) which is configured to provide service in non-terrestrial networks;
at least one electronic device (3) which is configured to realize data exchange by using any remote communication protocol;
at least one server (4) which is configured to control the users's need for updating ephemeris update, and to examine the sending status of state vector and orbital parameters within the scope of ephemeris data.

The gNodeB base station (2) included in the inventive system (1) is an application of a 5G New Radio (NR) base station using 3GPP standards. The gNodeB base station (2) is configured to provide service in non-terrestrial networks. The gNodeB base station (2) is configured to control whether one or both of state vector or orbital parameter groups should be updated. The gNodeB base station (2) is configured to transmit only the state vector or only the orbital parameter groups on the basis of the update requirement. The gNodeB base station (2) is configured to send the parameters related to both state vector and orbital for ephemeris, to the electronic devices (3) over SIB so as to be updated. The gNodeB base station (2) is configured to control the validity periods of the state vector and orbital parameters. The gNodeB base station (2) is configured to send only the outdated state vector or orbital parameters to the electronic devices (3) over SIB in order to update them.

The electronic device (3) included in the inventive system (1) is a device such as mobile phone (handsets) configured to run at least one application (3) and/or interface on itself. The electronic device (3) is configured to establish communication with remote servers by using any remote communication protocol and to realize data exchange. In a preferred embodiment of the invention, the electronic device (3) is configured to reduce the power consumption of both its own and the gNodeB base stations (2) by updating only the outdated data.

The server (4) included in the inventive system (1) is configured to establish communication with the electronic device (3) by using any remote communication protocol. In one preferred embodiment of the invention, the server (4) is configured to control the users' need for updating ephemeris. In another embodiment of the invention, the server (4) is configured to examine the sending status of state vector and orbital parameters within the scope of ephemeris data.

### INDUSTRIAL APPLICABILITY OF THE INVENTION

In the inventive system (1), data included in ephemeris are divided into two, namely state vector and orbital parameters. The parameters are shared between the gNodeB base stations (2) and the server (4) in two main groups. The gNodeB base station (2) and the server (4) enable to send the parameters related to both state vector and orbital for ephemeris, to the electronic devices (3) over SIB. Only the outdated state vector or orbital parameters are sent to the electronic devices (3) over SIB in order to update them.

Within these basic concepts; it is possible to develop a wide variety of embodiments of the inventive “System for Providing Ephemeris Transmission in Non-Terrestrial Networks (1)”; the invention cannot be limited to examples disclosed herein and it is essentially according to claims.

1. A system (1) for providing power save while transmitting ephemeris data from satellites to telephones/user devices, and reducing the signalling load created by system information; comprising
a gNodeB base station (2) which is configured to provide service in nonterrestrial networks;
at least one electronic device (3) which is configured to realize data exchange by using any remote communication protocol;
and characterized by
at least one server (4) which is configured to control the users's need for updating ephemeris update, and to examine the sending status of state vector and orbital parameters within the scope of ephemeris data.

2. A system (1) according to claim 1; characterized by the gNodeB base station (2) which is an application of a 5G New Radio (NR) base station using 3 GPP standards.

3. A system (1) according to claim 1; characterized by the gNodeB base station (2) which is configured to provide service in non-terrestrial networks.

4. A system (1) according to claim 1, characterized by the gNodeB base station (2) which is configured to control whether one or both of state vector or orbital parameter groups should be updated.

5. A system (1) according to claim 1, characterized by the gNodeB base station (2) which is configured to transmit only the state vector or only the orbital parameter groups on the basis of the update requirement.

6. A system (1) according to claim 1, characterized by the gNodeB base station (2) which is configured to send the parameters related to both state vector and orbital for ephemeris, to the electronic devices (3) over SIB so as to be updated.

7. A system (1) according to claim 1, characterized by the gNodeB base station (2) which is configured to control the validity periods of the state vector and orbital parameters.

8. A system (1) according to claim 1, characterized by the gNodeB base station (2) which is configured to send only the outdated state vector or orbital parameters to the electronic devices (3) over SIB in order to update them.

9. A system (1) according to claim 1, characterized by the electronic device (3) which is a device such as mobile phone configured to run at least one application (3) and/or interface on itself.

10. A system (1) according to claim 1, characterized by the electronic device (3) which is configured to establish communication with remote servers by using any remote communication protocol and to realize data exchange.

11. A system (1) according to claim 1, characterized by the electronic device (3) which is configured to reduce the power consumption of both its own and the gNodeB base stations (2) by updating only the outdated data

12. A system (1) according to claim 1, characterized by the server (4) which is configured to establish communication with the electronic device (3) by using any remote communication protocol.

13. A system (1) according to claim 1, characterized by the server (4) which is configured to control the users'need for updating ephemeris.

14. A system (1) according to claim 1, characterized by the server (4) which is configured to examine the sending status of state vector and orbital parameters within the scope of ephemeris data.

15. A system (1) according to claim 2, characterized by the gNodeB base station (2) which is configured to provide service in non-terrestrial networks.

16. A system (1) according to claim 2, characterized by the gNodeB base station (2) which is configured to control whether one or both of state vector or orbital parameter groups should be updated.

17. A system (1) according to claim 2, characterized by the gNodeB base station (2) which is configured to transmit only the state vector or only the orbital parameter groups on the basis of the update requirement.

18. A system (1) according to claim 2, characterized by the gNodeB base station (2) which is configured to send the parameters related to both state vector and orbital for ephemeris, to the electronic devices (3) over SIB so as to be updated.

19. A system (1) according to claim 2, characterized by the gNodeB base station (2) which is configured to control the validity periods of the state vector and orbital parameters.

20. A system (1) according to claim 2, characterized by the gNodeB base station (2) which is configured to send only the outdated state vector or orbital parameters to the electronic devices (3) over SIB in order to update them.
